(19) United States
(12) Patent Application Publication
(10) Pub. No.: US 2014/0349847 A1
(43) Pub. Date: Nov. 27, 2014

(54) PLANT TREATMENT METHOD

(71) Applicant: BRIGHT RAY SOLAR CORP., Guelph (CA)

(72) Inventor: Glen Schrader, Guelph (CA)

(21) Appl. No.: 14/362,147

(22) PCT Filed: Nov. 30, 2012
(86) PCT No.: PCT/CA2012/001104

§ 371 Date: Jun. 2, 2014

Related U.S. Application Data
(60) Provisional application No. 61/566,223, filed on Dec. 2, 2011.
(60) Provisional application No. 61/590,899, filed on Jan. 26, 2012.
(60) Provisional application No. 61/724,648, filed on Nov. 9, 2012.

(51) Int. Cl. C05B 17/00; C05G 3/02; C05F 11/00

(52) U.S. Cl. CPC C05B 17/00; C05F 11/00; C05G 3/02
USPC 504/100; 71/24

(57) ABSTRACT

Plant propagation material treated with a carbonaceous material is provided. Such treated plant propagation material is useful in a method of inducing microbial interaction with the plant propagation material that confers a benefit on the plant propagation material. The method includes placing the treated plant propagation material in a growth medium containing endogenous soil microorganisms.

### FIELD OF THE INVENTION

The present invention relates to treatment of plant propogation material, and in particular, relates to application of a carbon-based treatment onto plant propogation material.

### BACKGROUND OF THE INVENTION

Carbon-based materials have been long known to promote plant vigor and crop yields when used as a soil amendment under appropriate conditions. Terra Preta, or Black Earth, in the Amazon is one such early example of a high carbon material that increases plant productivity. To achieve desired effects, carbon-based material is applied to soil at very high rates, in the range of tonnes per hectare, which generally results in unprofitable economics.

When added to the soil carbon based materials provide a general benefit to many soil-borne microbes, including both mutualistic and pathogenic microbes. Soil amendments, as described in U.S. Pat. No. 8,236,085, do offer limited, indirect benefit to the plant by improving the characteristics of the soil, such as increasing soil porosity and water retention. However, the greatest benefit occurs when a soil microbe confers benefit to a plant via a mutualistic relationship. Many terrestrial plants benefit from entering into a mutualistic relationship with soil microbes such as Arbuscular Mycorrhiza (AM) Fungi, also referred to as arbuscular mycorrhizal fungi or vascular arbuscular mycorrhiza (VAM). In 2001, Schussler et al. estimated that 80% of terrestrial plants form such mutualistic relationships. When used as a soil amendment, carbon-based materials benefit a multitude of soil microbes without providing a preferential promotion or stimulation of plant benefiting microbes. Further, this benefit to soil microbes may not spatially or temporally coincide with plant growth, especially plant germination.

To try to increase the probability of microbe-plant mutualistic relationships, seeds have been treated with a microbial inoculant or similar topically applied treatment. There are multiple benefits of such plant inoculation including enhanced plant vigor, health, growth, yield, and enhanced resistance to environmental stresses and pests. For example, U.S. Pat. No. 8,101,551 describes the use of Clonostachys rosea strain 88-170 as a seed inoculant, a soil treatment, or a treatment of plant cuttings/transplants. U.S. Pat. No. 6,524,998 relates to use of rhizobacteria in conjunction with chitosan to promote plant growth, plant health and produce disease resistant plants. However, in some cases, microbes introduced via an innoculant may have difficulty becoming established within the soil, resulting in poor field performance.

There has been concern over the use of an inoculants comprising a single species or strain of microbe via seed treatment across vast geographic distances. The concern generally relates to the possibility of decreasing genetic diversity in populations of plant benefiting soil microbes and thereby increasing the likelihood of widespread hardship resulting from an outbreak of disease or a predator of the introduced microbe. There is also concern that an introduced species may not be as well adapted or beneficial to plants as endogenous soil microbes.

Some seed treatments also include an organic carrier, such as peat. U.S. Pat. No. 5,586,411, for example, describes a seed treatment in which peat is said to act as a carrier of a Penicillium- and Rhizobium-based co-inoculant. While peat is an effective carrier of microbial spores, helping to preserve the viability of the inoculant microbe, it does not provide economically significant stimulation or growth promoting properties to plant benefiting microbes when used as a seed treatment.

AM Fungi and other soil microbes are known to form assemblages of symbiotic relationships with other microbes as well as with plants. Grassland plants are expected to have seven to eleven microbial mutualistic partners each. Each microbial guild or species in the assemblage can confer different benefit to the plant. Under certain circumstances, the microbe-plant relationship may transiently or permanently change from mutualistic to commensalism or parasitism. The plant and/or microbe typically will reduce or exit a less beneficial relationship and form new relationships with other available partners. The interactions within the microbe-plant assemblage can be complex. Microbes were believed to be either plant-growth promoting or biocontrol agents; however, it has more recently been shown that most microbes that provide plant-growth promoting effects, also provide a biological control benefit. Similarly, most microbial biological control agents also confer a plant-growth promoting benefit. For example, AM fungi, generally accepted as a plant-growth promoting microbe can decrease the negative impact of root-knot nematodes, such as Meloidogyne incognita, to plant roots and thus act as a biological control agent. There are numerous examples of inoculants that confer multiple, independent, microbe-plant mutualistic relationships. One such example is the co-inoculation of seeds with both a nitrogen fixing Rhizobacteria and a biological control agent such as Bacillus firmus. US Pat No 20080320615 describes plant inoculants comprising two separate pathogen antagonists, Trichoderma virens and Bacillus amyloliquefaciens, in which each inoculant is intended to act as a biological control agent to the plant and is tolerant of the antimicrobial activities of the other.

Seed treatments that contain carbon materials, such as humic acid, are available. In U.S. Pat. No. 7,001,869, humic acid was an optional additive in the seed treatment. Humic compounds have been shown to benefit common millet (Panicum miliaceaum) with an amount of about 60 kg humic acid per 100 kg seed having the greatest effect. Unfortunately, many modern seed planters for row crops are limited with respect to the amount of seed treatment they can handle, and this is often below 5 kg per 100 kg seed. Binders can make the treated seed more durable and suitable for the planting equipment, but at the cost of decreasing the available surface area. Polymers can be designed with high surface areas, but they lack the heterogeneity of high carbon materials. Numerous polymeric based seed treatments have been described. U.S. Pat. No. 7,774,978 describes a polymeric seed coating that provides controlled release of agriculturally active ingredients. U.S. Pat. No. 6,329,319 describes how polymeric seed coatings can provide to the seed various properties that result in benefit to the seed.

It would be desirable to develop an improved seed treatment that overcomes one or more of the disadvantages of prior seed treatments, and thereby provides benefit to plants grown from seeds exposed to such a treatment.

### SUMMARY OF THE INVENTION

A novel treatment has now been developed in which plant propagation material is treated to provide an environment that encourages growth of beneficial microorganisms which provide favourable growth conditions for the plant and thereby growth benefits to the plant.

Thus, in one aspect of the present invention, plant propagation material treated with a carbonaceous material is provided, wherein the carbonaceous material is inert and is applied to the plant material.

In another aspect of the invention, a method of treating a plant propagation material is provided comprising applying a carbonaceous material to the plant material, wherein the carbonaceous material is applied in an amount of no more than about 10% of the mass of the plant material.

In a further aspect of the invention, composition is provided comprising a carbonaceous material combined with at least one binder.

In another aspect of the invention, a method of inducing a microbial interaction with plant propagation material that confers a benefit on the plant propagation material is provided comprising applying an inert carbonaceous material to the plant propagation material and placing the plant propagation material in a growth medium containing endogenous soil microorganisms.

In another aspect of the invention, use of a composition for treating a plant propagation material is provided wherein the composition comprises an inert carbonaceous material combined with a binder.

These and other aspects of the present invention are described in the following detailed description by reference to the following figures.

### DETAILED DESCRIPTION OF THE INVENTION

Plant propagation material treated with a carbonaceous material is provided. The treated plant material provides an environment that encourages the growth of microorganisms which are beneficial to the plant and provide growth benefits to the plant.

As used herein, the term “plant propagation material” is meant to encompass any plant material capable of growing into full plant, and may include, for example, natural or artificial seeds, plant material containing an embryo, totipotent cells, pluripotent cells or meristematic cells, asexual plant propagation material, such as scion cuttings such as stems tip cuttings, medival cuttings, cane cuttings, single eye cuttings, double eye cuttings, heel cuttings, leaf cuttings such as whole leaf with petiole, whole leaf without petiole, split vein, leaf sections, root cuttings, eye cuttings, air or ground layering such as tip layering, simple layering, compound layering, mound layering, division, tubers, bulbs, corms, rhizomes, stolons or runners, twin-scaling offsets, separation, grafts such as bud grafts, whip and tongue graft, cleft grafting, bark grafting, patch budding, chip budding, t-budding, and plant micropropagation material such as plant tissue culture and somatic embryonic material.

To prepare the treated plant propagation material, a carbonaceous material is topically applied to the plant material. The term “carbonaceous material” includes solid carbon material comprising greater than 50% carbon by mass which is substantially inert to microbial growth. It is stable in the soil, resists microbial degradation and typically has a resident half-life of over 100 years in aerobic soils. The carbonaceous material has a surface area of greater than 1 m² per gram, and preferably greater than 100 m² per gram, such that it is hygroscopic, and exhibits desiccant properties. The carbonaceous material can, thus, advantageously, function as a preservative.

Examples of suitable carbonaceous materials include, but are not limited to, biochar, charcoal, coal including anthracite, lignite, sub-bituminous, bituminous, flame coal, gas flame coal, gas coal, fat coal, forge coal and nonbanking coal, humin, lignin-containing biomass, a mixture of carbon nanostructure materials, and other biomass pyrolysis or carbonization products or derivatives resulting from such processing including activated carbon and coke. The carbonaceous material may also comprise mixtures of any of these materials. Generally, biochar is produced by the thermal treatment of biomass, such as wood, in an environment in which there is insufficient oxygen to allow complete combustion but the biomass material is changed and volatile compounds such as water and volatile organic compounds are lost. The mass ratio of carbon within biochar is transformed to greater than 50%, and the surface area of the biochar, per equivalent grain size, is increased from that of the biomass starting material.

The carbonaceous material may be of any grain size suitable for use to treat plant propagation material in accordance with the invention. Generally, carbonaceous material comprising particles of smaller grain sizes, increases the surface area of the treatment in a given mass quantity of the carbonaceous material. Thus, the carbonaceous material may have an average grain size of less than 5 millimeters in diameter. Preferably, the average grain size of the carbonaceous material is less than 3 millimeters in diameter, and more preferably, the average grain size of the carbonaceous material is less than 1 millimeter in diameter and greater than 0.1 millimeter in diameter. In addition, the surface area of the carbonaceous material is generally greater than 1 m²/gram, for example, greater than 50 m²/gr, preferably greater than 100 m²/gr, for example, at least about 300 m²/gram, such as greater than 1000 m²/gram.

The carbonaceous material is topically applied to the plant propagation material in a form that is suitable for the type of plant propagation material being treated, storage conditions of the plant material and the nature of the technology used in the plant propagation protocol. For example, plant propagation material, such as oat seed, comprising sufficient texture to retain the treatment, may be appropriately treated by dry topical application of the carbonaceous material. Alternatively, the carbonaceous material may be suspended in a fluid and applied to the plant material, such as corn (Zea mays) seed, or a Kalanchoe spp. cutting. The carbonaceous material may be suspended in any fluid appropriate for application to plant propagation material, i.e. fluid that does not have a substantial adverse effect on the plant propagation material, such as water or other aqueous solution.

The amount of carbonaceous material topically applied to the plant material to achieve desirable benefits may vary with a number of factors, including the nature of the carbonaceous material used for the treatment, the plant material being treated e.g. the type of plant material and the type of plant, as well as the microorganisms targeted, the benefit to be achieved, and the microbial loading (beneficial as well as pathogenic microorganisms) in the growth medium. The mass of carbonaceous material to be applied to a plant material to achieve desirable benefits may be determined by one of skill in the art using standard plant propagation protocols. Generally, the mass of carbonaceous material to be applied to a plant material in an amount sufficient to achieve desirable benefits which may be less than about 50%, and preferably less than about 10%, of the mass of the plant material. In one embodiment, the mass of carbonaceous material applied to seed plant material may be less than about 10% of the mass of the plant material, for example, less than about 3%, 1%, or at about 0.1%. In the treatment of a plant cutting, for example, at a stem-branch junction, dosages of less than about 0.1% of the mass of the plant material mass may be used. In another embodiment, in the treatment of plant tissue culture e.g. isolated vascular material in culture to be differentiated into a callous or root material, a mass of carbonaceous material of greater than 10% of the plant material mass may be used. In addition to a determination of the mass of carbonaceous material to be applied in the treatment of plant propagation material, the thickness of the carbonaceous material applied, which may form a coating, is preferably compatible with plant propagation protocol and equipment. Thus, the carbonaceous material is preferably applied at a thickness of no more than about 3 millimeters, and preferably a thickness of less than 3 millimeter, for example, less than 2 millimeters, or less than 1 millimeter.

In an alternative embodiment, plant propagation material may be treated indirectly to achieve benefits to a resultant plant. Such indirect treatment is conducted by application of carbonaceous material to a growing medium followed by placement of the plant propagation material in or adjacent to the carbonaceous material within the growing medium. In this embodiment, the parameters of the carbonaceous material, e.g. surface area, grain size and amount, are as described for direct topical treatment of plant propagation material. The carbonaceous material may be combined with one or more additives to form a composition in which the effects of the carbonaceous material may be enhanced. For example, the carbonaceous material may be applied directly to the plant propagation material. Alternatively, the carbonaceous material may be combined with one or more binders to facilitate application of the carbonaceous material to the plant material, and thereby improve the handling characteristics of the carbonaceous material. Examples of suitable binders include, but are not limited to, water; triglyceride based plant oils such as soya, canola, sunflower, corn or olive oils; adhesives such as glues or thickening agents used to improve adherence of the carbonaceous material to the plant material. Some examples of glues include: rice paste, proteins, wax esters such as various fish and copepod-based waxes, and polymeric materials such as UNICOAT™ and AQUACOAT™ (Universal Coating Systems), CF-Clear, 74A, and Secure™ (Becker Underwood), Cistrocoat™ (Cistronics Technovations Pvt. Ltd.), Intellicoat™ (Landec Corporation). Such binders and thickening agents are added in an amount which increases binding of the carbonaceous material to the plant material which is not detrimental to the plant material, for example, a concentration of up to about 10 times the mass of the carbonaceous material. Examples of suitable thickening agents include plant isolates such as guar gum, acacia gum, tragacanth, arabic gum, gluten, pectin, starch, carrageenan, agars, cellulose and hemi-cellulose based thickeners, animal isolates such as gelatin, microbial isolates such as xanthan gum, glomalin and glomalin-like proteins, and the like. It should be noted that additives may provide more than one function within the treatment, for example a starch-based binder can also act as a food source for soil microbes, and a polymer based binder can also act as a diluent. Other diluents may include biologically-inert diluents such as sand, or non-biologically-inert material such as cellulose or peat.

The carbonaceous composition may include one or more additives which benefit, prime, and/or signal soil microorganisms in the soil that are beneficial to the plant to be treated with the composition. Examples of plant beneficial soil microorganisms include. arbusular mycorrhizal fungui (AMF) such as Glomus intraradices and additionally, but not limited to: Scutellospora castanea; Glomus spp., such as G. mosseae, G. fasciculatus; Gigaspora spp. such as G. rosea; Pseudomonas spp, such as Pseudomonas cepacia, and Pseudomonas fluorescens; Corynebacterium spp; Gaeumannomyces spp., such as Gaeumannomyces graminis; Bacillus spp., such as B. subtilis, B. thuringiensis, B. amyloliquefaciens; Paenibacillus spp. such as Paenibacillus lentimorbus; Gliocladium spp., such as Gliocladium virens; Burkholderia spp., such as Burkholderia cepacia; Enterobacter spp., such as E. cloacae, Trichoderma spp. such as T. viride, T. virens, T. harzianum, T. roseum, T. Koningii, T. hamatum; Thielaviopsis spp., such as T. basicola, Alternaria spp., Verticillium spp. such as V. dahlia; Exobasidiellum spp., Gliocladium spp. such as G. roseum, Gonatobotrys spp. such as G. simplex, Sphaeronaemella spp., such as S. helvellae, Penicillium spp., such as P. Oxalicum, Streptomyces spp., such as S. lydicus, Clonostachys spp., such as C. rosea. As will be appreciated, additives which preferentially select for endogenous, highly cooperative bacteria or fungi into a microbe-plant assemblage of mutualistic microbe partners, may result in increased benefit to the resultant plant. The term “mutualistic’ refers to a symbiotic relationship in which each organism in the relationship benefits from the relationship. Mutualistic soil microorganisms may be more likely to enter into a mutualistic relationship with plant propogation material that signal or provide benefit to the microorganisms. Examples of additives that benefit, prime, and/or signal soil microorganisms include, but are not limited to, nutrients such as nitrates, phosphates, bio-available copper, bio-available iron, energy sources including plant isolates such as guar gum, acacia gum, tragacanth, arabic gum, gluten, pectin, wheat (Triticum spp) flour and other forms of starch, cellulose and hemi-cellulose based compounds, lignin, animal isolates such as gelatin, microbial isolates such as xanthan gum, glomalin and glomalin like proteins, algae isolates including carrageenan, agars, algin acid, laminarin, synthetic or multiple sourced materials e.g. sugar alcohols like mannitol, triglycerides and other fatty acid esters, such as olive oil, canola oil, wax esters like oilfish isolates, fatty alcohols such as oleyl alcohol, and fatty acids such as oleic acid and linolenic acid. Compounds which facilitate plant development and microbe-plant mutualism, such as abscisic acid, jasmonic acid, flavonoids and salicylates such as salicylic acid are also suitable additives.

The carbonaceous material may be combined with a microbial inoculum for application to a plant in order to establish a particular plant-microbe-microbe-plant interaction and to potentially incur a predictable result on the plant material. Suitable inoculum for this purpose may include one or more plant beneficial microorganisms as identified above. Inoculum titer used may be in the normal usual range for such titers; however, due to the microbial-stimulating properties of the present carbonaceous material plant treatment, a lower inoculum titer may be applicable. As one of skill in the art will appreciate, the inoculum may include one or more plant beneficial microorganisms. For example, the inoculum may include AM fungi as well as a biological control agent, e.g. a fungal parasite such as Verticillium dahlia, such that the AM fungi serves as a host to the biological control agent. The inoculum may include AM fungi along with a saprophyte, such as Penicillium oxalicum, to provide plant growth promoting benefit and/or biological control, and the AM fungi provides exudates that benefit the saprophyte. These treatments may be further supplemented with one or more additives to further enhance the benefit provided to the plant material.

The carbonaceous composition may include plant growth additives to enhance the benefits conferred by the carbonaceous material on plant growth. Such additives are well-known in the art and may include, but are not limited to, macronutrients such as a nitrogen source (e.g. ammonium, nitrates and the like), a phosphorous source (e.g. phosphoric acid), and a potassium source (e.g. potash), micronutrients such as boron, copper, iron, calcium, magnesium, sulfur, selenium, manganese, molybdenum, zinc and iodine, either in chelated form or applied in combination with a chelating agent such as EDTA, and vitamins and cofactors important for plant germination and growth such as thiamine, riboflavin, niacin (nicotinic acid and/or niacinamide), pyridoxine, panthenol, cyanocobalamin, citric acid, folic acid, biotin and combinations thereof. Plant growth additives may be added in amounts that positively impact on plant growth and which are conventionally used in the art. These additives may be taken up directly by the plant, or may be taken up by a soil microbe and then passed onto the plant via a plant-microbe interaction.

Addition of compounds that stimulate the growth of certain plant parts may also be incorporated in the composition, for example, auxins such as indole-3-butyric acid, α-naphthalene acetic acid, indole-3-acetic acid, 4-chloroindole-3-acetic acid, 2-phenylacetic acid, 2,4-dichlorophenoxyacetic acid and 2-methoxy-3,6-dichlorobenzoic acid, cytokinins such as kinetin and zeatin, 6-benzylaminopurine, diphenylurea, thidiazuron, ethylene and gibberellins, which stimulate root growth and/or arbuscule formation.

The carbonaceous composition may also include, or be applied to a seed treated with, a pesticide and/or fungicide which prevent the growth of undesirable seed borne or soil microorganisms, e.g. soil microorganisms which are detrimental to a plant such as, but not limited to pathogenic forms of Diplodia(Stenocarpella), Sporisorium (Sphacelotheca), Mucor, Rhizopus, Aspergillus, Cladosporium, Helminthosporium, Phialophora, Macrophomina, Phytophthora, Meloidogyne, Heterodera, Anguina, Sclerotinia, Pseudomonas, Diaporthe, Phomopsis, Tilletia, Gaeumannomyces, Pythium, Rhizoctonia, Fusarium, Colletotrichum, and Penicillium. Examples of suitable pesticides or fungicides for this purpose include Abamectin, Azoxystrobin, Clothianidin, Fludioxonil, Imidacloprid, Ipconazole, Mefenoxam, Metalaxyl, Myclobutanil, Pyraclostrobin, Thiamethoxam, Thiabendazole, Thiodicarb, Trifloxystrobin, Tridimenol and 2-(Thiocyanomethylthio) benzothiazole (TCMTB). Pest inhibitors may also be included in the composition which inhibit various pests such as birds, rodents and insects. Examples of pest inhibitors include, but are not limited to, chemical insecticides such as organophosphates, pyrethroids and neonicotinoids, inorganic materials such as aresenates, copper and sulfur, and biological control agents such as Bacillus spp. Examples of suitable plant extracts that act as deterrents to herbivores include cayenne pepper, capsaicin, lemon extract, garlic extract and peppermint oil. Such compounds may be added in amounts conventionally used in plant treatment, or may be used in smaller amounts if their activity is supplemented by the activity of a mutualistic microbe.

In preparing a carbonaceous composition in accordance with the invention, the carbonaceous material is first processed, if required, by grinding, to yield a material having an appropriate particle size. The carbon may optionally be prepared into a slurry by addition of water or other aqueous fluid. Additives which may have an adverse effect if applied directly to the plant material are added to the carbonaceous material and allowed to incubate with the carbon for a time sufficient to permit absorption of these additives by the carbon. In addition, additives having a longer efficacy period may be added early in the preparation process so that subsequent additives block the diffusion thereof from the carbonaceous material. Heat may be applied to the carbon in certain cases to facilitate a deep diffusion of additives into the carbonaceous material and subsequent slow release thereof. Additives that are intended to be readily available to target soil microbes are generally added to the carbon material later in the process and function also to block in place additives added earlier in the process.

It will be understood by the skilled person that the additives may be combined with a carbonaceous material for application to a plant propagation material as a composition, or alternatively, may be separately applied to the plant propagation material. For example, the carbonaceous material may be applied prior or subsequent to the application of one or more plant growth additives, pesticides, herbicides or microbial priming or signaling additives, or in combination with such additives as described.

The present treatment may be tailored to achieve a particular outcome with the plant propogation material treated, for example, to stimulate and/or promote the conversion and/or development of a specific plant tissue, such as roots. This is useful to control the type of growth, particularly when applied to cuttings where increased root growth is desirable and to tissue culture where a specific plant tissue is desirable, such as unorganized parenchyma cells in a callus, transformation of an pre-existing tissue type to another, such as transformation of stem vascular tissue into root tissue, promotion of senescence, induction of a new tissue such as root growth from stem material, or for somatic embryogenesis.

The application of the carbonaceous material or a composition comprising a carbonaceous material to plant propagation material results in a benefit to the resultant plant. “Benefit” when used to describe benefit conferred to a resultant plant includes, but is not limited to, one or more of the following: increased plant vigor, darker green and healthier looking foliage, increased growth rate of stems and foliage, larger stems and foliage, faster maturation of the plant, greater number of tillers per plant, greater number of reproductive organs such as flowers, florets or flowers per inflorescence, seeds, cobs and kernels per cob, greater size of reproductive organs such as larger flowers, larger seeds, more seeds per cob, earlier and more complete canopy closure, earlier setting of flowers and other reproductive structures including seed, increased plant health, greater resistance to environmental stress such as drought and pathogenic organisms, increased uptake of nutrients, higher nutrient concentration in plant tissue, reduced uptake of heavy metals, reduced heavy metal concentration in plant tissue, increased systemic disease resistance, recruitment of endogenous mutualistic soil microbes, preferential selection by the plant of highly cooperative mutualistic soil microbes into the symbiotic assemblage, and recruitment of a plurality/assemblage of mutualistic soil microbes species as symbiotic partners, selective recruitment of different soil microbe species dependant on the additives present and concentration of additives within the current invention, increased advantage in competition against weed species, reduced senescence of plant tissue including foliage loss due to environmental stress, reduced need for the application of common agricultural chemicals such as phosphate fertilizer and pesticides, ability to increase the formation of new plant tissue such as a callus or new roots, the ability to direct the transformation of new tissue type such as the transformation of stem vascular tissue into root tissue, and increased efficiency of somatic embryogenesis such as increased callus survival and increased differentiation of a callus to a new plant.

The present method of applying a carbonaceous material and/or a composition comprising a carbonaceous material directly to plant propagation material provides many advantages. At the outset, the use of an inert carbonaceous material avoids contamination of plant propagation material with undesirable microbes, permitting greater control over the growing environment of the plant material and the ability to tailor the growth environment to that which facilitates the growth of desired microorganisms. Additionally, the dessicant properties of preferred carbonaceous materials provide preservation of additives, such as oils and carbohydrates, to a carbonaceous composition to increase shelf-life of the composition and treated plant propagation material.

As a result of the growth benefits conferred on the resultant plant, the present method results in a clear economic advantage due to a increase in crop yield and quality, and a reduction in crop loss. The present method also reduces the need for additional agricultural chemicals, including growth promoting fertilizers, herbicides, pesticides and fungicides. In addition, in view of the increased growth and resistance of resultant plants to disease, and the concomitant reduced need for chemical fertilizers, pesticides and herbicides, the present invention also provides a significant environmental advantage.

Embodiments of the invention are described in the following examples which are not to be construed as limiting.

### Example 1

### Materials

For all trials, unless otherwise specified, the Activated Carbon, 15-30-15 Fertilizer, AMF source and method of preparation were as follows:

AMF: Glomus intraradices, Myke® Pro Landscape, Premier Tech Biotechnologies (1 ave Prmier River-du-loup Quebec, G5R 6C1, lot 120238), 1 viable propagule/gr.

Fertilizer: Commercial grade NPK (15-30-15) plant fertilizer. Plant Prod Ulitmate, Flowering Plant Fertilizer, 500 g size, Sure-Gro IP Inc. Min Analysis: Total N 15%, Available Phosphoric Acid (P2O5) 30%, Soluble Potash (K2O) 15%, Boron (actual) 0.02%, Chelated copper (actual) 0.05%, chelated iron (actual) 0.10%, chelated manganese (actual) 0.05%, Molybdenum (actual) 0.0005%, chelated zinc (actual) 0.05%, EDTA (chelating agent) 1%.

Activated Carbon: Aqua-tech activated carbon, commercial grade activated carbon for aquarium filter. 4 oz (113.4 g) size. United Pet Group, Inc. The activated carbon (100 g) was mixed with water and ground in a blender for three minutes until a slurry was formed, with an average particle size of less than 1 mm. Commercial grade activated carbon has an average surface area of over 500 m²/gram.

The method of treating seeds was as follows: (1) water was added to the activated carbon; (2) the activated carbon was ground in a blender to make slurry with grain size ranging from 0.05 mm to 1 mm, adding water as necessary; (3) if applicable, the slurry was filtered to remove particles outside this range; (4), if applicable, nutrients were added and mixed by hand; (5) if applicable, energy/food sources was measured, added and mixed by hand; (6) if applicable, other additives were measured, added and mixed by hand; (7) measured out seed; (8) placed seed to be treated into mixing container, such as a zip-lock bag or similar appropriate container; (9) if applicable, binder material was measured, added and mixed by hand; (10) measured out seed treatment mixture and placed into mixing container; to make up for residual mixture left on container walls and added in a correction amount of mixture, such as +10%; and (11) mixed and turned the seeds and seed treatment mixture by hand until seeds were evenly coated.

Unless otherwise stated, oat seed was planted to a depth of 1 cm to 3 cm. Corn (Zea mays) seed was planted to a depth of 3 cm to 5 cm.

### Methods.

A germination of Soybean (Glycine max) test was conducted indoors in pots using biotic field soil at ambient room temperature and under ambient room light. 20 untreated control seeds, 20 seeds treated with TS W2 (10 g of activated Carbon and 10 g of 15-30-15 Nitrogen-Phosphate-Potassium fertilizer suspended in water and applied at a dosage of 3% treatment material per seed v/v) and 20 seeds treated with TS W2F (TS W2 with 20% v/v food grade wheat (Triticum spp.) flour added in). None of the seeds were inoculated or otherwise treated except as described above. The test ran for 16 days, at which point the plants were harvested.

### Results.

Germination rate, plant height and leaf length were tabulated and are set out below in Table 1.

TABLE 1
16 Day Soybean (Glycine max) germination trial

| | | | | V1 | V1 Leaf |
|---|---|---|---|---|---|
| | | | Germination | Height | Length |
| | | n | Rate | (cm) | (mm) |
| Control | Mean | 20 | 100% | 10.9 | 21.5 |
| | Median | | | 10.5 | 21.0 |
| TS W2 | Mean | 20 | 100% | 12.1 | 21.3 |
| | Median | | | 12.8 | 21.0 |
| TS W2F | Mean | 20 | 100% | 11.6 | 22.7 |
| | Median | | | 11.5 | 23.0 |

As shown in Table 1, the treated seeds had the same germination rate as the control group. The W2 Treated Seed was able to recruit at least one soil microbe that stimulated plant height. The W2F Treated Seed was able to recruit at least one soil microbe that promoted plant development as demonstrated by earlier V1 leaf development resulting in the increased leaf length.

This test also demonstrates that different additives change the probability of guild recruitment by the plant as TS W2 was more likely to result in the plant recruiting a plant stimulating mutualistic microbial partner whereas TS W2F was more likely to result in the plant recruiting a plant promoting mutualistic microbial partner. Thus, seed treatment additives impact the soil microbe recruited and in turn the benefit conferred to the plant.

This test further demonstrates that the current seed treatment is compatible with and confers benefit to dicotyledonous plants.

### Example 2

A germination test of Oats (Avena sativa) was conducted indoors in pots using biotic field soil at ambient room temperature and under ambient room light. 20 seeds were treated with TS W2 and stored at ambient room temperature and humidity until planting 1 week later. After 10 days, 19 of the 20 seeds had germinated. Mean plant height after 11 days was 16.2 cm and median height was 17.0 cm. The high growth rates suggest that the plants were able to recruit at least one soil microbe that stimulates plant growth.

This test demonstrates that treated seeds were viable and had typical germination rates even after 6 weeks storage in a plastic bag kept at ambient room temperature.

### Example 3

A germination test of Oats (Avena sativa) was conducted indoors in pots using biotic field soil at ambient room temperature and under ambient room light. Untreated (Control), W2, W2F, and W2B treatments were used. W2B treatment was similar to W2F as described in Example 1, but the treatment material was additionally boiled for 2 minutes. Additional water was added to this material following boiling to top up liquid levels in view of evaporation. 15 ml of treated seed were planted.

Results were recorded 13 days following planting as set out in Table 2. DNG denotes Did Not Germinate. The variance in the seed count in the 15 ml was due to seed clumping as a result of the seed treatment and thus not packing as tightly as the untreated control. No other seed treatment was used. Avg refers to the mean average height, expressed in cm. Median height is also expressed in cm.

TABLE 2

| | Control | W2F | W2B | W2 |
|---|---|---|---|---|
| N | 192 | 131 | 148 | 158 |
| Mean Height (cm) | 7.1 | 12.2 | 10.8 | 8.9 |
| % boost | 0% | 72% | 52% | 26% |
| St Dev | 4.1 | 5.1 | 5.5 | 10.0 |
| Median Height (cm) | 7.0 | 13.0 | 11.5 | 9.0 |
| DNG | 22 | 21 | 14 | 18 |

The treated seeds exhibited increased plant growth in height as indicated by a comparison of control and average plant heights, and thus, the treated seeds were able to recruit growth-promoting microbes.

The high variability of the W2 treatment represented a bimodal height distribution that was indicative of only partial recruitment of a plant growth promoting soil microbe. It seems that those plants that were able to recruit a microbe grew at a rate similar to W2B and those that did not had a height similar to the control group.

With respect to the W2B treatment, it is believed that heating the W2B treatment allowed the wheat flour to further penetrate the activated carbon, decreasing the available surface area of the activated carbon and reducing the amount of flour available as an energy source for the soil microbes. The net effect was that W2B was less effective than W2F at promoting and stimulating plant beneficial microbes which in turn resulted in less growth in plants from W2B treated seeds than in plants from W2F treated seeds.

With respect to the W2F treatment, the results show that flour as an additive greatly increases the efficacy of the seed treatment, presumably by providing a food source for soil microbes to result in greater promotion and stimulation of plant beneficial soil microbes. It is quite possible that the sugar from the flour was made available to the plant mutualistic microbes such as AM fungi via a second soil microbe, such as a saprophyte, that release digestive enzymes into the soil, digesting the flour and increasing the availability of amino acids, sugars, and other nutrients for the microbes.

Due to the small amount of the nutrition available in the W2F treatment, it is reasonable to assume that within a couple of days, all the nutrition available from the wheat flour had been consumed. The continuing benefit of W2F over the other treatments indicates that the plant benefitting microbe recruited by the plant in the microbe-plant mutualistic relationship were more cooperative than those recruited by the control and other treatments. A more cooperative microbe is one that offers greater benefit to the plant, i.e. more nitrogen or phosphate, per unit of sugar offered by the plant in exchange.

### Example 4

A germination test of Corn (Zea mays) was conducted indoors in pots using biotic field soil at ambient room temperature and under ambient room light. The plants were grown for 14 days after the first signs of emergence. The treatments were as follows: 12 plants control (untreated); 12 plants AM Fungi inoculation only; 12 plants with treatment D13 with AM fungi inoculation of which 8 were at 10% treatment per seed v/v dosage and 4 were at 30% treatment per seed v/v dosage; and 12 plants with treatment D13 of which 8 were at 10% treatment per seed v/v dosage and 4 were at 30% treatment per seed v/v dosage. Treatment D13 was fine grain activated carbon, i.e. <50 micrometer diameter with 10% v/v of 15-20-15 N-P-K fertilizer with water added to form a paste. The paste was then topically applied to the seed. Seed was inoculated with AM fungi by creating a slurry of Myke® Pro Landscape, Premier Tech Biotechnologies, 1 ave Prmier River-du-loup Quebec, G5R 6C1, lot 120238, 1 viable propagule Glomus intraradices/gr and soaking the seed for 10 minutes in the slurry. The seeds were not otherwise treated.

The results are shown in Table 3. Minimum, mean and maximum plant height was measured.

TABLE 3

| | | Min | Mean | Max |
|---|---|---|---|---|
| | N | (mm) | (mm) | (mm) |
| Control | 10 | 102 | 155 | 180 |
| AMF only | 10 | 87 | 169 | 227 |
| TS D13 with AMF | 6 | 147 | 189 | 223 |
| TS D13 only | 5 | 140 | 193 | 229 |

Because the soil had a very high amount of freshly decomposing soy plants and a resulting high load of saprophytic and pathogenic microbes, high mortality rates were seen. In both the D13 only and D13 with AMF treatments, the high dosage of treatment in the presence of a high pathogen load resulted in 75% plant mortality. This is evidence that the treatment is capable of creating a microbial bloom. At lower dosages, the plant was able to enter into mutualistic microbe-plant relationships even in the presence of a high pathogen load. However at higher dosages, the increased microbial bloom resulting from the treatment, can include a bloom of pathogenic microbes or increased virulence of the pathogens which in turn overwhelms plant defenses and results in very high plant mortality rates.

As shown in Table 3, the AMF only treatment indicates that AMF is capable of entering into a plant-microbe relationship to the benefit of the plant. Treatment with D13 only was capable of recruiting endogenous soil microbes into a mutualistic microbe-plant relationship that was very similar in scale to plants that were first inoculated with AMF and then treated with D13. This suggests that the treatment is capable of stimulating and promoting soil microbes to enter into a mutualistic relationship with the seedling. Further the treatment works well at promoting and stimulating plant benefiting soil microbes that are either inoculated or endogenous to the soil.

As the minimum height of D13-treated plants is significantly higher than in either the AMF only inoculated seed or the control, it suggests that D13 is capable of conferring benefit to the plant beyond the natural benefit conferred to the plant by an AMF-plant mutualistic relationship. Considering the maximum height in relation to the mean height of the different treatments, it appears the benefit of the treatment results more from the ability to increase the recruitment frequency of beneficial soil microbes rather than a direct promotion or stimulation of the plant by the treatment.

### Example 5

The University of Guelph was contracted under a service agreement to test the impact of 4 seed treatments on germination and development of corn (Zea mays) up to the 5 leaf stage. The research was carried out by Dr. Swanton and Dr. Afifi. The plants were grown with a surplus of available nutrients and water. Thus the test did not test any stress tolerance benefits conferred by treatments used.

### Material and Methods:

Maize seeds (Zea mays L.) of the University of Guelph maize hybrid (CG 108 X CG 102) were used in this experiment. A combination of mycorrhizal inoculant (AMF) and the commercial grade plant fertilizer (NPK 15-30-15) were used as a seed treatment in combination with either olive oil or soybean margarine. Active carbon was used in all treatments (exception control) in order to retain nutrients within the growing substrate and to minimize seed decay.

A total of 100 seeds per replication were utilized; twenty five treated seeds per treatment. Twenty-five seeds were coated with the mix of (AMF) and the fertilizer by using olive oil to adhere the AMF to the seed coat (treatment B). Another 25 seeds of maize were coated with the same mixture by using soybean margarine (treatment C). Moreover, 25 maize seeds were coated with the same mixture by using only 10 volumes of water (treatment D). As a control, 25 maize seeds were used without any treatment (A). Maize seeds of each treatment were planted (one seed per pot), within 25 cm diameter, 19 cm tall 6 L pots (Airlite Plastics Company, Omaha, Nebr., USA). The pots were filled with a mix of (1:1) blend of LB2 soil (LB2 Mix Basic, Sun Gro, Sunshine Horticulture, Vancouver, British Columbia, Canada) and Turface. LB2 soil was selected because it does not contain any nutrients, thus, allowing control of fertilization. Turface (Turface MVP; Profile Products LLC, Buffalo Grove, Ill., USA) is a 100% backed calcined clay growth media with grain size between 2.5 and 3.5 mm.

Maize seedlings were watered every two days from planting through harvest at 5^{th} leaf tip stage of growth. Throughout this experiment, maize seedlings were fertigated twice (at the second leaf tip stage and one week later) using a nutrient solution including a 40 g mixture containing 290 g N per kg, 61 g P per kg, and 116 g K per kg, and 40 g of a mixture containing 150 g N per kg, 66 g P per kg, and 249 g K per kg soluble fertilizer supplemented with trace-mineral salts (Plant Products Co. Ltd., Bramalea, Ont.), 20 g NH4NO3, 40 g MgSO4-7H20, and 1 g Mn chelate (120 g Mn per kg) dissolved in 100 L tap water and adjusted with HCL to pH 5.8. The first time Seedlings were placed within a growth cabinet (Conviron, Winnipeg, Canada) set to 20/15° C., 16/8 h light/dark regime and 60-65% humidity. Irradiance was supplied by a s liding bank of Sylvania Cool White fluorescent tubes and inside-frost tungsten 40 W bulbs delivering 500 umol m⁻² s⁻¹ PPFD. Percent seedling emergence was recorded based on the penetration of the initial shoot emergence above-ground. At the 5^{th} leaf tip stage of maize (21 days after planting), seedlings were harvested to measure different morphological parameters. Morphological measurements included seedling height measured from above the highest crown root to the tip of the tallest maize leaf; stem height measured to the second visible leaf collar from above the highest crown root and stem diameter measured 2 cm above the first node. Roots were washed under running tap water and separated from the above-ground stem by cutting just above the highest crown root. The number of crown roots for each seedling was recorded. Once all shoots and roots were measured, all plant components were bagged separately and dried at 80° C. to a constant weight.

The results are shown in Table 4. Mean values are shown, different letters are significant at (Turkey's test at P≦0.05).

TABLE 4

| | Treatments | | | |
|---|---|---|---|---|
| Parameters | A | B | C | D |
| Plant height | 42.89 (a) | 37.82 (b) | 41.22 (a) | 41.81 (a) |
| (cm) | | | | |
| 2^{nd} leaf | 8.62 (a) | 8.13 (ab) | 7.91 (b) | 7.75 (b) |
| collar (cm) | | | | |
| Stem | 9.23 (bc) | 9.02 (c) | 9.53 (ab) | 9.89 (a) |
| diameter | | | | |
| (mm) | | | | |
| Crown No. | 8.04 (b) | 8.26 (b) | 8.69 (ab) | 9.43 (a) |
| Shoot | 0.64 (a) | 0.52 (b) | 0.62 (a) | 0.65 (a) |
| biomass (g) | | | | |
| Root | 0.42 (a) | 0.37 (b) | 0.40 (ab) | 0.42 (a) |
| biomass (g) | | | | |

Most notable is that even under optimal growing conditions, Treatment D was able to promote plant development resulting in an increase in crown root numbers by 17% over the control. Crown root number in young corn is positively correlated to crop yields. Additionally, Treatment D was able to stimulate plant growth, with a 7% increase in stem diameter over the control. Stem diameter in young corn plants is a proxy of overall plant health.

It should be noted that all the treated seeds had a shorter distance to the second leaf collar than the control. This suggests that the between germination and second leaf collar development, the plants entered into a mutualistic relationship with the inoculated AM fungi and were allocating resources to the AM Fungi at the expense of early shoot growth. AM Fungi are most commonly understood in their roll of exchanging water and phosphate extracted from the soil and offered to the plant in exchange for plant produced sugars. The AM Fungi were also able to confer both promotional and plant stimulation benefits to the plant, even under ideal growing conditions. The increase in the crown root number in Treatment D shows that plant development was promoted. The ability of plants in Treatment D to go from 90% the height of control plants at the V2 stage to 97% the height of control plants at the V5 stage shows that in order to catch up to the controls, the Treatment D plants were growing faster than controls between the V2 and V5 stages. This is evidence that the present treatment conferred plant growth stimulating benefits onto treated, even under ideal growing conditions.

The dosage trials in the later field test (Example 6) showed that the dosages applied in this study were too high to provide maximal benefit to the plant. It is reasonable to assume that the treatment, especially when a food source was added, such as the oils in Treatments B and C, was capable of promoting and stimulating a broad range of soil microbes. It was postulated that some of the corn kernels were contaminated with a pathogen fungi. In the presence of high soil moisture along with the resources provided by Treatments B and C, the resulting microbial bloom had a high population of pathogenic microbes. This in turn lead to a higher frequency of pathogens being able to overwhelm the corn seed, rot and kill it. The differences in germination rates between Treatments B, C, and D shows that different additives has a differential impact on the resulting microbial bloom with resulting differential impact to the plant. Thus, by controlling the composition of the current invention, modifying the dosage and the additives, we can statistically control the microbial response to the current invention. The different microbial responses in turn have different impact on the plants, such as increased mortality in Treatment B versus increased plant promotion and stimulation in Treatment D. One well versed in the art can see that different recipes of the current invention can thus statically confirm predicable differential impact to the resultant plant.

### Example 6

A further field trial under permit from the Canadian Food Inspection Agency Research Authorization under the Fertilizers Act, was performed with 117 treatments on corn seeds (Zea mays). The source corn seed was Pioneer Premium Seed Treatment (PPST) 250, which contains 4 pesticides.

TABLE 5

| Treatment Code | Description |
|---|---|
| “N” Class | Any treatment within this trail where the Treatment Code Starts with “N” |
| N30W | 100 volumes of ground activated carbon with 30 volumes of Nitrogen |
| | fertilizer and water added. Applied at a dosage of 3% treatment to seed. |
| N30O | Treatment N30W but with 3% v/v Olive Oil added |
| N30R | Treatment N30W but with 3% v/v Canola Oil added |
| N30S | Treatment N30W but with 3% v/v Soy Margarine added |
| N10W | 100 volumes of ground activated carbon with 10 volumes of Nitrogen |
| | fertilizer and water added |
| N10R | Treatment N10W but with 3% v/v Canola Oil added |
| N10S | Treatment N10W but with 3% v/v Soy Margarine added |
| N1W | 100 volumes of ground activated carbon with 1 volume of Nitrogen |
| | fertilizer and water added |
| N1O | Treatment N1W but with 3% v/v Olive Oil added |
| AH_{—} | Treatments including: AHW, AHO, AHR, AHS |
| AHW | 100 volumes of ground activated carbon with 15 volume of Nitrogen |
| | fertilizer, 30 volumes of Phosphate fertilizer, 3 volumes of AMF inoculant |
| | filtered to <1 mm particle size, and water added |
| AHO | Treatment AHW but with 3% v/v Olive Oil added |
| AHR | Treatment AHW but with 3% v/v Canola Oil added |
| AHS | Treatment AHW but with 3% v/v Soy Margarine added |
| D10W | 100 volumes of ground activated carbon with 15 volume of Nitrogen |
| | fertilizer, 30 volumes of Phosphate fertilizer, and water added. Applied at |
| | a dosage of 10% of treatment to seed. |
| D3W | 100 volumes of ground activated carbon with 15 volume of Nitrogen |
| | fertilizer, 30 volumes of Phosphate fertilizer, and water added. Applied at |
| | a dosage of 3% of treatment to seed. |
| D_W | Treatments including: D10W, D3W |
| D_O | Treatments including D10O, D3O |
| D10O | Treatment D10W but with 3% v/v Olive Oil added |
| D3O | Treatment D3W but with 3% v/v Olive Oil added |
| D3R | Treatment D3W but with 3% v/v Canola Oil added |
| D1W | 100 volumes of ground activated carbon with 15 volume of Nitrogen |
| | fertilizer, 30 volumes of Phosphate fertilizer, and water added. Applied at |
| | a dosage of 1% of treatment to seed. |
| D1O | Treatment D1W but with 3% v/v Olive Oil added |
| D10_{—} | Treatments including: D10W, D10O |
| D3_{—} | Treatments including: D3W, D3O, R3R |
| T3W | 100 volumes of ground activated carbon with 30 volumes of Phosphate (as |
| | trisodium phosphate) and water added. Applied at a dosage of 3% of |
| | treatment to seed. |
| T3O | Treatment T3W but with 3% v/v Olive Oil added |
| T3R | Treatment T3W but with 3% v/v Canola Oil added |
| P3W | 100 volumes of ground activated carbon with 30 volumes of Phosphate |
| | fertilizer and water added. Applied at a dosage of 3% of treatment to seed. |
| P3R | Treatment P3W but with 3% v/v Canola Oil added |

The treated corn seed was hand planted to an average depth of 3 cm. There was no pesticide application, fertilizer application, irrigation, or other intervention during the trial. It should be noted that the trials were subjected to a 6 week drought. The drought had significant impact on all tests. Corn plants were showing increased leaf die back as well as low growth rates. Over 90% of the oat plants died from the drought and they had 100% death of above ground foliage.

Within the first 2 weeks, the corn plants treated with nitrogen additive but no phosphate, the “N” group of treatments, were visibly doing better than all other treatments. This was especially evident in the N30S and N30R treatments. The N10S and N10R plants were maybe 10% shorter but had only one third the amount of nitrogen available in the treatment. Additionally, the N30W and N300 treatments were shorter than the N10S and N10R plants even though they had three times the amount of nitrogen as the N10 plants. This suggests that the boost was related to the amount of nitrogen available to the plant, but that the nitrogen wasn't only from the seed treatment. Indeed, it suggests that the nitrogen in the seed treatment was responsible for the plant preferentially recruiting a mutualistic microbe into its assemblage that was highly cooperative or otherwise effective in supplying soil sourced nitrogen to the plant.

Unfortunately, most of the “N” class treated plants were killed at about 2.5 weeks. It is unknown if they were preferentially preyed upon by a local flock of Canadian geese or other predator or if the “N” group of treatments resulted in increased mortality from pathogen or other cause. The “N” group treatments all had a dosage of 3% treatment material per seed (v/v). The lack of residual plant material suggests that the plants were preyed upon. Similarly, much of the “AH” group of treatments were similarly missing/killed. “AH” treatments contained a high rate of nitrogen (15%) and phosphate (30%) fertilizer in addition to an AM fungi inoculation. Dosage of “AH” treatments was 3% treatment material per seed (v/v). The ingredients were mixed with water to produce a slurry. Four treatments within the “AH” group included: AHW, with the composition as described above; AHO which was AHW but with 3% v/v food grade olive (Olea spp.) oil added to it; AHR which was AHW but with 3% v/v food grade canola (Brassica spp.) oil added to it; and AHS which was AHW but with 3% v/v food grade soya (Glycine spp.) margarine added to it.

One month later, various morphological parameters of the treated seed were measured. Selected results are set out in Table 6 below.

TABLE 6

| | Treatment | Control |
|---|---|---|
| Parameter | D10W | Group |
| Plant Height (mean) | 105 cm | 78 cm |
| Plant Height - tasseled | 108 cm | 84 cm |
| plants only (mean) | | |
| Green Leaf Count | 10.1 | 8.7 |
| Tassel Frequency | 95% | 33% |
| Cob Frequency | 73% | 8% |

About 10 days later:

TABLE 7

| | Treatment | Control |
|---|---|---|
| Parameter | D10W | Group |
| Tassel Frequency | 95% | 75% |
| Cob Frequency | 88% | 60% |
| Second Cob Frequency | 15% | 0% |
| (of plants with a | | |
| primary cob) | | |

The data in Table 5 suggests that the D10W plants were able to recruit at least one plant benefiting microbe into its microbial assemblage that conferred a plant stimulating benefit, as the average plant height was greater than that in the control group. The data also suggests that the D10W plants were able to recruit at least one plant benefiting microbe into its microbial assemblage that conferred a plant promoting benefit, as both the tassel and cob frequency was higher than compared to the control. Even 10 days later, the development of the control plants had not caught up as the tassel and cob frequencies in the control were still below those seen in the D10W plants 10 days earlier (Table 6). The data also suggests that the D10W plants were healthier as they had a greater number of green leaves per plant than did the control.

Samples of cobs from the plants were taken about 1 month later and dried overnight at 60° C. Treatment D10W averaged cob weight of 46.5 grams whereas the average control cob weight was 31.7 grams. Secondary cobs, taken from treatment D10W averaged 24.0 grams, significantly smaller than the primary cob average of 46.3 grams. Only a single plant in the control group produced a secondary cob. D3W plants with cobs had a secondary cob incidence of 9%. D10W plants with cobs had a secondary cob incidence of 15%. Predation of primary cobs in the “D_W” and “D_O” treat groups always resulted in secondary cob development and occasionally a tertiary and higher order cob numbers.

A comparison of D3W and D10W treated seeds (identical treatments except that D10W contains 3 times more nitrogen and phosphate), showed clear differences in resultant plant benefit as shown in Table 8.

TABLE 8

| Trait | Control | D3W | D10W |
|---|---|---|---|
| Height | 78 cm | 99 cm | 103 cm |
| Green Leaf Count | 8.7 | 10.1 | 10.4 |
| Tassel Frequency | 33% | 75% | 89% |
| Cob Frequency | 8% | 43% | 56% |

The D10W treatment offered both increased promotion of plant development over the D3 W treatment as seen in the increased tassel and cob frequencies. Additionally, the D10W treatment had a greater stimulation of plant growth, having both greater height and more green leaves than did D3W. Both D3W and D10W outperformed the control in all 4 metrics. The difference in N and P available to the plant from the applied seed treatment was less than a milligram between the treatments and the control. Clearly, the differences are not a direct result of utilization of the N and P by the plant. Instead, it is reasonable to assume that the N and P in the D_W treatments was first taken in by a soil microbe and the nutrients made available by the D_W treatments primed them for a cooperative and long lasting mutualistic relationship with the plant that conferred benefit to the plant resulting in the increased morphological characteristics. The D3W and D10W treatments had the same additives and relatively similar amounts of nutrients taken from the treatment. Thus, the data suggests that higher initial nutrient concentrations allows the plant to be more selective in its recruitment, appearing to preferentially select a more cooperative mutualistic microbe to recruit into its assemblage compared to those that were recruited by the D3W plants. A more cooperative mutualistic microbe is one that offers greater benefit to the plant per cost exchanged, such as more units of phosphate taken by the plant per unit of sugar given to the microbe. The data shows that the D10W treatment consistently outperformed all other treatments and thus the benefit was established early, e.g. soon after germination, and continued for the entire growing season.

However, a pair wise comparison of D3O and D10O shows a very different result. This comparison of low vs high nutrient loading (3% vs 10% NPK) in the presence of an energy source (3% olive oil) is set out in Table 9.

TABLE 9

| Trait | Control | D3O | D10O |
|---|---|---|---|
| Height | 78 cm | 96 cm | 71 cm |
| Green Leaf Count | 8.7 | 10.5 | 9.8 |
| Tassel Frequency | 33% | 90% | 0% |
| Cob Frequency | 8% | 10% | 0% |

The addition of an energy source which provided the soil microbes with more nutrients allowed for a greater microbial bloom than in the D_W group. Indeed the D10O group had 90% mortality within the first 2 weeks compared to 25% mortality in the D10W group and 26% mortality in the control group. The D3O group had 75% mortality and the D1O group had 23% mortality. Clearly, slight differences in treatment had a big impact on the initial microbial bloom and in some cases the treatment promoted and stimulated pathogen microbes to a degree that overwhelmed the plants defenses. Additionally, the microbial bloom that resulted from D10O treatment overwhelmed the plants ability to preferentially recruit cooperative mutualistic microbes. Other than green leaf count, the D10O plants received less benefit from their microbial assemblage than did the control plants.

The impact of the seed treatment on the resultant microbial bloom that coincides with the seed germination had impact that lasted the duration of the growing season. This highlights that the topical treatment to the plant propagation material achieved the desired microbial bloom and mutualistic priming which spatially and temporally overlaps with when the first plant roots enter the soil and these first microbial recruitments into the plant-microbe assemblage had season long impact.

Pair wise comparison of the addition of an energy source (3% olive oil) at low nutrient loading (3% NPK) (Table 10) and high nutrient loading (10%) (Table 11) was as follows:

TABLE 10

| Trait | Control | D3W | D3O |
|---|---|---|---|
| Height | 78 cm | 99 cm | 96 cm |
| Green Leaf Count | 8.7 | 10.1 | 10.5 |
| Tassel Frequency | 33% | 75% | 90% |
| Cob Frequency | 8% | 43% | 10% |

TABLE 11

| Trait | Control | D10W | D10O |
|---|---|---|---|
| Height | 78 cm | 103 cm | 71 cm |
| Green Leaf Count | 8.7 | 10.4 | 9.8 |
| Tassel Frequency | 33% | 89% | 0% |
| Cob Frequency | 8% | 56% | 0% |

These results indicate that additives and the concentration of the additives may be customized for local conditions, such as crop species, soil moisture, soil pathogen load, soil load of mutualistic microbes, species of soil mutualistic microbes, temperature, soil nutrient level, and other factors that impact both plant and microbial growth. Going from a 3% NPK fertilizer loading to a 10% NPK fertilizer loading, without an energy source, i.e. D3W and D10W, resulted in an average increased benefit to the plant in all parameters measured. However, the addition of 3% olive oil to the D10_{—} group, i.e. D10O, had a net detrimental effect to the plant. Comparison of D3O to D3W shows that the olive oil itself is not causing the harm to the plant, as D3O had similar height, more tassels, but fewer cobs than D3W. Clearly the difference in benefit resulted from different priming of soil microbes and differential recruitment by the plant of the microbes into the plant-microbial assemblage.

Additionally, the type of energy source has an impact on the resultant microbial bloom and, thus, the microbes recruited into the plant assemblage. D3O and D3R treatments are identical except for the energy source, olive oil in the D3O treatment and canola oil in the D3R treatment. Clearly it is not only the presence of the energy source but also its composition that have an impact on the benefit provided to a treated plant. Changing the composition affects the microbial bloom and, thus, the recruitment of microbes into the plant assemblage as shown by a comparison of the effects of these treatments on corn seeds. In addition, a different benefit was conferred onto the plants with the different energy sources. In the case of D3O, the resultant plants gained both plant stimulation and plant promotion benefit from the treatment, as compared to the control. However, D3R showed a decrease in plant height and decrease in cob frequency when compared to the control.

TABLE 12

| Trait | Control | D3O | D3R |
|---|---|---|---|
| Height | 78 cm | 96 cm | 68 cm |
| Green Leaf Count | 8.7 | 10.5 | 9.1 |
| Tassel Frequency | 33% | 90% | 37% |
| Cob Frequency | 8% | 10% | 0% |

As expected, recipe sequence can have a dramatic impact on the benefit conferred to a plant. In the T3O treatment, olive oil was applied to the seed first and then the nutrient-laden activated carbon was added to it. For the T3W treatment, the olive oil was added to the nutrient laden activated carbon. It is reasonable to assume that directly adding olive oil to the seed will decrease the integrity of the seed leading to increased mortality, and that adding the olive oil to the activated carbon allows it to absorb into the activated carbon to result in a less detrimental effect on the seed. Indeed, this was seen as T3W had a mortality rate of 22%, compared to the control group mortality of 26%, whereas T3O had a mortality rate of 85% (Table 13). Combining additives with the activated carbon allows the additives to absorb into the carbon based material, permitting microbial activity at the surface of the carbon based material. Combining additives directly with the seed can move microbial activity onto the seed coat. Additionally, the chemical properties of the additive are more likely to impact the seed if they are added directly to it rather than adding them to the carbon based material and allowing them to be absorbed by the carbon material. In the case of T3O, the oil can serve to soften the seed coat as well as promote pathogenic growth on the seed coat.

TABLE 13

| Trait | Control | T3W | T3O |
|---|---|---|---|
| Height | 78 cm | 70 cm | 68 cm |
| Green Leaf Count | 8.7 | 8.5 | 7.7 |
| Tassel Frequency | 33% | 6% | 0% |
| Cob Frequency | 8% | 3% | 0% |
| Mortality Rate | 26% | 22% | 85% |

A comparison of P3R and T3R was conducted as shown in Table 14. The two treatments were similar, but P3R has 3% phosphate at a neutral pH, whereas T3R has 3% phosphate in the form of trisodium phosphate, resulting in a high pH. If the phosphate had moved out into the soil and acted on the soil microbes at a distance from the treatment, it is expected that pH of the phosphate would be buffered by materials within the soil. However, if the microbes were interacting proximal to the treatment, then the high pH of the treatment is expected to inhibit microbial growth, resulting in no benefit or a decrease in recruitment of beneficial microbes into the assemblage. T3R additionally had the canola oil additive applied first to the seed and then the nutrient laden carbon based material applied. P3R had an all canola oil additive added to the nutrient laden carbon based material, and then the mixture was applied to the seed. This helps explain the increased mortality of the T3R plants. But even for the plants that survived a weakened seed coat, the treatment was not able to encourage plant promoting beneficial microbes from entering into a relationship with plant, as tassel and cob frequency was lower than control. The data suggests that treatment T3R was less effective than the control at being able to recruit a plant stimulating microbe from entering into a relationship with the plant.

In addition, the neutral pH of the P3R treatment did not inhibit microbial activity and the P3R treatment was effective in stimulating and promoting a bloom of primed highly cooperative mutualistic microbes. This is demonstrated by P3R showing plant stimulation benefits with both height and leaf count being greater than the control and T3R, as well as P3R showing plant promoting benefit as shown by both increased tassel and cob frequency over both control and T3R (Table 14).

TABLE 14

| Trait | Control | P3R | T3R |
|---|---|---|---|
| Height | 78 cm | 93 cm | 75 cm |
| Green Leaf Count | 8.7 | 9.8 | 9.0 |
| Tassel Frequency | 33% | 59% | 0% |
| Cob Frequency | 8% | 29% | 0% |
| Mortality Rate | 26% | 15% | 82% |

Hence, additives that stimulate a specific microbe will increase the likelihood of that microbe interacting with the plant assemblage. Similarly, an additive that stimulates a microbial guild will increase the likelihood of that specific guild benefit being incorporated into the assemblage and related benefit conferred to the plant. Likewise, additives that inhibit microbes will also confer a predictable result upon the treatment. Additives that inhibit pathogens can increase benefit of the treatment, but additives that provide an inhibition of mutualistic microbes can decrease the benefit of that treatment. Guild and species specific interactions can be tailored to create a desired effect. An example of this would be the inclusion of an antibiotic as an additive to inhibit pathogens coupled with inoculation by a plant benefiting microbe that is resistant to the added antibiotic. This would help the inoculated microbe gain preferential benefit and can help statistically increase the likelihood of the inoculated microbe conferring its benefit to the resultant plant, even though the antibiotic additive is inhibitory at the guild level.

Additive overloading can result in a decrease in the preferential priming of highly cooperative microbes as shown by a comparison of D3R and P3R treatments (Table 15). D3R and P3R treatments were similar, but D3R treatment included nitrogen while P3R did not. In this case, the resulting microbial bloom was less specific with more microbes being able to take advantage of the food and nitrogen available from D3R. This resulted in a decrease of phosphate-primed, highly cooperative microbes in the bloom and a decrease in the benefit conferred to the plant by treatment with D3R, with all metrics being less than with the P3R treatment. Without the available nitrogen, the microbial bloom created by P3R was smaller, and the plant was better able to distinguish primed, highly cooperative mutualistic microbes and, thus, preferentially recruit them into the plant's microbial assemblage. The result was that P3R was able to confer greater benefit to the plant, with all 4 metrics being greater than the control and D3R treatment.

TABLE 15

| Trait | Control | P3R | D3R |
|---|---|---|---|
| Height | 78 cm | 93 cm | 67 cm |
| Green Leaf Count | 8.7 | 9.8 | 9.1 |
| Tassel Frequency | 33% | 59% | 37% |
| Cob Frequency | 8% | 29% | 0% |

### Example 7

A trial of oat seed treatments was conducted. 100 grams of untreated, animal-feed grade oats (Avena sativa) were treated as follows.

TABLE 16

| Treatment | Composition |
|---|---|
| W1 | Untreated Control |
| W1a | AMF inoculated seed treated with W1 |
| W2 | Activated carbon wetted with water at dosage of 3% treatment |
| | material to seed v/v |
| W2a | AMF inoculated seed treated with W2 |
| W3 | Activated carbon wetted with water, mixed with an equal |
| | volume of 15-30-15 NPK fertilizer applied at dosage of |
| | 3% treatment material to seed v/v |
| W3a | AMF inoculated seed treated with W3 |
| W4 | Activated carbon wetted with water, mixed with an equal |
| | volume of trisodium phosphate and 10% volume olive oil |
| | applied at dosage of 3% treatment material to seed v/v |
| W4a | AMF inoculated seed treated with W4 |

The oats were spread over a 0.5 square meter test plot and then covered with an average of 1 cm soil. There was no pesticide application, fertilizer application, irrigation, or other intervention during the trial. It should be noted that the trials were subjected to a 6 week drought. The drought had significant impact on all tests. Over 90% of the oat plants died.

Selected sample heights of oat plants were taken at about 2 weeks and 1 month from the start of the trial as follows:

TABLE 17

| Treatment | 2 Weeks | 1 Month |
|---|---|---|
| W1 | 12 cm | 12 cm |
| W1a | 12 cm | 12 cm |
| W3 | 15 cm | 15 cm |
| W3a | 15 cm | 19 cm |

At about 2 weeks, the drought was reducing plant growth. All the “a” treatments, those with AMF inoculation, had much fuller plots, with the plants having wider blades and darker color than their non-inoculated counterpart. Although the plant heights showed little difference at 2 weeks, there were noticeable visual differences, suggesting that AMF inoculation consistently imparted a plant benefit.

At 1 month, many of the plants had stopped growing and leaf tips were dying. All the “a” treatments, those with AMF inoculation, continued to have fuller plots, with the plants having wider blades, and darker color than the non-inoculated counterpart. In addition, all the “a” treatments appeared to have received some drought benefit, in that leaf tips were not as wilted as the counterpart treatment. Additionally, the “a” treatments retained a dark green color while the counterparts were noticeably lighter/yellow-green. Treatment W3a had an average height increase between 2 weeks and 1 month from the start of the trial. This suggests that treatment W3a imparted a measure of drought resistance to the plants.

At about 6 weeks, all the above ground portion of the plants were severely affected by the drought, as dead or dying.

At about 8 weeks, some of the oat plants began to re-grow. While more than 95% of the population had died from the drought stress. Of those that survived, the W3a group clearly outperformed the W1 and W1 a controls. Observed benefits conferred by treatment W3a to the oat plants included: greater survival rate, more tillers per plant, greater stalk diameter, taller plants, more florets, and more flowers per floret. This is additional evidence of drought tolerance being conferred to the W3a plant.

The oat and corn trials (Examples 6 and 7) demonstratethat the present treatments stimulate plant growth within the Poaceae family. This is significant in that grasses are sometimes grown for biomass and turf applications rather than crop yield. Crops such as switchgrass and miscanthus that are grown for biomass purposes, sugarcane grown for sugar, and turf grasses such as Poa spp. and Festuca spp. are all plants grown for economic purposes that can benefit from the current treatments.

In plants that survived the drought, the current treatment provided significant benefit to the plant as demonstrated in tiller numbers. Both the mean and median number of tillers on treatment W2, the activated carbon by itself is capable of increasing the mean number of tillers by 64% and the median number of tillers by 130% over the W1 control. The addition of AMF by itself results in only a 3% increase in mean tillers in treatment W1a over W1. The additives included in treatments W3 and W4 were able to increase the benefit conferred to the plant over both Treatment W2 and the W1 control. The additives in treatments W3a and W4a were able to increase benefit to the plant over both treatment W2a and W1a.

TABLE 18

| Treatment | W1 | W1a | W2 | W2a | W3 | W3a | W4 | W4a |
|---|---|---|---|---|---|---|---|---|
| Surviving | 7 | 11 | 5 | 10 | 7 | 13 | 9 | 10 |
| Plants (n) | | | | | | | | |
| Mean | 3.9 | 4.0 | 6.4 | 6.5 | 9.9 | 9.5 | 8.4 | 11.3 |
| Tillers (n) | | | | | | | | |
| Median | 3.0 | 3.0 | 7.0 | 7.0 | 7.0 | 8.0 | 9.0 | 9.5 |
| Tillers (n) | | | | | | | | |

### Example 8

A compost test was also performed, in which samples from each of the treatments in Example 6, totaling 500 grams of treated seed, was buried in the field at a depth of 10 cm. 500 grams of control seed material was also tested, also buried at 10 cm depth. The 2 tests were separated by a distance of 4 meters. One month later, the tests were excavated and examined. The treated seed had a very high rate of germination and some plants were able to reach the surface and emerge. Additionally, there was a very high amount of fungal growth through the test material. So much so that it was held together as a single mass that had to be broken apart. There was no apparent rot in the seed mass. Earthworms were present near and throughout the seed mass. Earthworms showed typical behaviour and responsiveness and were present at a rate similar to the surrounding soil. The control mass had a noticeable lower degree of germination and no plants emerged. The humidity of the control seed mass was noticeably lower. There was no evidence of fungal growth amongst the seeds and the seeds were free flowing in that there was no seed-seed adherence. No earthworms were present within the seed mass. Both groups were mixed up to kill any germinated plants and to randomly redistribute the seeds. They were then reburied.

The seeds were again excavated and examined 17 days later. The control group now had a foul, rotting odor with strong notes of butyric acid, from what appeared to be anaerobic bacterial decomposition of the killed seedlings and decomposing plant tissue. The majority of the seeds still maintained a high degree of integrity, appearing to be dry and still viable. The treated seed group had greater than 90% germination rates and the fungal mass had re-grown. Despite having a higher amount of killed plant material from the previous examination, these seeds had an earthy smell, indicative of high actinomycete and fungal activity decomposing the killed plant material. The soil had dried out below the test zone and no earthworms were seen either in the surrounding soil or in the seed masses. Both samples were reburied.

Three months later, the seeds were again excavated and examined. In the control group, there was no remaining evidence of any corn seed. Earthworms were present within the test area at a rate similar to the surrounding soil and displayed typical behavior and responsiveness. In the treated seed, there remained traces of the activated carbon as well as some traces of seed coats in tight association with the activated carbon. Earthworms were present within the test area at a rate similar to the surrounding soil and displayed typical behavior and responsiveness.

The compost test suggests that the treated seeds resulted in greater accumulation of soil carbon than the control. The test also suggests the treatment leads to greater soil microbial activity and health than the control. Neither the control nor the treated seed showed any noticeable impact on local earthworm population or health. Weeds and planted soybeans grew near and over the test plots at similar rates and density as that of the surrounding suggesting that neither test had any appreciable impact on nearby plants.

### Example 9

3 Kalanchoe plants were purchased from Home Depot. Flowers were cut-off and then the plants were segmented into 14 portions ranging from 40 mm to 100 mm. 6 segments included a stem branch node so that the plant segment ended in a “v”. 8 segments included the portion above a leaf node or stem node, providing “straight” ends. 3 of the “v” segments and 4 of the straight segments were topically treated with W2 as in Table 15. Water was added so that the treatment material was a thick paste. Approximately 2 cm of plant material at the end of each segment was painted with the treatment material to a thickness of approximately ½ to 1 mm.

Soil was taken from a farm field. Holes were drilled into the soil at a depth of about 5 cm. Segments were placed into the holes and the soil was pressed back against the plant material such that the treatment was not scraped off while planting. Cuttings were grown at ambient room temperature and lighting. The results of the trial are shown below in Table 19.

TABLE 19

| | Control | W2 |
|---|---|---|
| # of roots >5 mm | 6 | 7 |
| Mean Root Length | 10 | 12 |
| (mm) | | |
| Median Root Length | 9 | 11 |
| (mm) | | |
| % Callous formation in | 0% | 0% |
| straight cuts | | |
| % Callous formation in | 0% | 67% |
| “v” cuts | | |
| % Root Formation from | 100% | 33% |
| Stem | | |
| % Root Formation from | 0% | 83% |
| Vascular Tissue | | |

All of the treated plants had accelerated necrosis of the stem segment below soil. In contrast, only 1 of the control plants showed any necrosis of stem material below the soil. Two of the treated “v” segments had callous development at the stem-branch node. In these two cases, necrosis only occurred in the portion of stem material beyond the callous, and the branch remained fully intact.

No callous formation was observed in the control plants. This demonstrates that the treatment was capable of stimulating callous formation in the plant material. Additionally, the W2 treatments had the unique effect of promoting the conversion of vascular tissue to roots. This was apparent in the straight cut segments, where the stem had undergone complete necrosis and vascular tissue converted to root material that then sent out numerous (>10), small (1 to 3 mm) lateral roots. Treatment W2 also stimulated root growth, with both number of long roots (>5 mm and average length of long roots being higher than the control.

AMF is generally considered an obligate mutualistic microbe with very little, if any, saprotrophic ability. The advanced necrosis of the stem material below the soil is indicative of increased saprotrophic activity in the W2 treated plants. However, the rapid yet incomplete degradation of the stem material and lack of disease in the W2 treated plants suggests that the saprotrophic activity was regulated and kept in check from becoming overly aggressive and pathogenic. The conversion of vascular tissue to root tissue in the W2 plants is a mechanism for a plant-microbe-microbe-plant interaction that confers benefit to the plant. Here the Kalanchoe spp. provides food to the recruited AMF via arbuscules in the newly formed roots. AMF then interacts with saprophytes such as penecillium spp, where the AMF releases proteins such as Glomulin and Glomulin-like proteins which the saprotroph can utilize as a food source. The rapid decomposition of the stem material below the soil suggests with low incidence of disease is indicative that the AMF and saprotrophs are communicating, signaling, or otherwise influencing growth and pathogenic responses by the saprothrophs. Some penecillium species confer plant promoting and/or biological control benefit to the plant. Additionally, bacteria, including but not limited to Bacillus pumilus, Bacillus subtilis, Bacillus thuringiensis, can benefit from AMF products released into the soil. These bacteria can confer plant promoting and/or biological control benefit to the plant.

This example illustrates that the present treatments can confer benefit to vegetatively propagated plant material, not just to seeds, including stimulation and promotion of benefits to the resultant plant.

### Example 9

Three treatments were applied to corn (Zea mays) seeds as set out below in Table 20. 10 seeds were treated per treatment (TF, TAC, TBC) at a dosage of approximately 10% volume of treatment material to volume of seed applied. The seeds were planted in a pot containing field soil and grown at ambient room temperature and lighting for 2 weeks.

TABLE 20

| Treatment | |
|---|---|
| Code | Description |
| TC | Untreated control |
| TF | 1 gram of 15-30-15 N-P-K fertilizer was mixed with water |
| | to produce a paste. |
| TAC | The Aqua-Tech activated carbon was ground with 300 grain |
| | sandpaper until about 1 gram of powdered carbon was |
| | produced. This was then mixed with water and 1 gram of |
| | 15-30-15 N-P-K fertilizer to produce a paste. |
| TBC | Biochar was prepared by taking 2 grams of fresh twigs from |
| | large-tooth aspen (Populus grandidentata), cutting into |
| | 1 cm segment, adding 2 grams of water and heating in a |
| | closed container to 500 p.s.i. pressure for 5 min. The resultant |
| | biochar was then ground with 300 grain sandpaper. 1 gram of |
| | 15-30-15 N-P-K fertilizer was added and mixed with water to |
| | produce a paste. |

Plants were watered every 3 or 4 days as the soil dried out.

TABLE 21

Treatment

| | TC | TF | TBC | TAC |
|---|---|---|---|---|
| N | 10 | 10 | 10 | 9 |
| Mean height (cm) | 10.3 | 10.2 | 11.4 | 11.8 |
| Median height (cm) | 10 | 10.5 | 12 | 13 |

The trails show that both the TBC and TAC treatment provided benefit over the control and the fertilizer only treatment. The activated carbon treatment conferred the greater benefit in terms of height, but also had 1 plant die. The fertilizer only treatment had a slight benefit in terms of median height and similar mean height. The lack of benefit from the fertilizer treatment may have resulted from the seeds being watered after planting and washing off the fertilizer treatment. Also, the field soil came from a soy bean rotation so it is assumed that soil nitrogen levels were not plant limiting.

1. Plant propagation material treated with a carbonaceous material, wherein the carbonaceous material is inert and is applied to the plant material.

2. Plant propagation material as defined in claim 1, selected from the group consisting of natural seeds, artificial seeds, plant material comprising an embryo, totipotent cells, pluripotent cells, meristematic cells, plant stems, leaves, roots, scion cuttings, eye cuttings, tubers, bulbs, corms, rhizomes, stolons, grafts, cell culture and somatic embryonic material.

3. (canceled)

4. Plant propagation material as defined in claim 1, wherein the carbonaceous material is selected from the group consisting of biochar, activated carbon, coke, charcoal, anthracite, lignite, sub-bituminous, bituminous, flame coal, gas flame coal, gas coal, fat coal, forge coal, nonbanking coal, humin, lignin-containing biomass, a mixture of carbon nanostructure materials and mixtures thereof.

5. Plant propagation material as defined in claim 1, wherein the carbonaceous material is applied in an amount of less than about 10% of the mass of the plant material, preferably less than 3% of the mass of the plant material, more preferably less than 1%.

6. Plant propagation material as defined in claim 1, wherein the carbonaceous material possesses an average grain size of less than 5 millimeters in diameter, preferably less than 3 millimeters in diameter, and more preferably, the average grain size of the carbonaceous material is less than 1 millimeter in diameter and greater than 0.1 millimeter in diameter.

7. Plant propagation material as defined in claim 1, wherein the carbonaceous material comprises a surface area of at least about 1 m²/gram, preferably greater than 100 m²/gr, and more preferably greater than 300 m²/gr.

8. Plant propagation material as defined in claim 1, wherein the carbonaceous material is applied at a thickness of no more than about 3 millimeters, preferably a thickness of less than 3 millimeters, more preferably less than 2 millimeters, or less than 1 millimeter.

9. Plant propagation material as defined in claim 1, wherein the carbonaceous material is combined with one or more of plant growth additives, plant nutrients, microbial nutrients, pesticides, herbicides, microbial inoculum, diluent and binder.

10. Plant propagation material as defined in claim 9, wherein the carbonaceous material is combined with at least one of a source of nitrogen, a source of phosphorous and a microbial nutrient.

11. A method of treating a plant propagation material comprising applying a carbonaceous material to the plant material, wherein the carbonaceous material is applied in an amount of no more than about 10% of the mass of the plant material.

12. The method of claim 9, wherein the plant propagation material is selected from the group consisting of natural seeds, artificial seeds, plant material comprising an embryo, totipotent cells, pluripotent cells, meristematic cells, plant stems, leaves, roots, scion cuttings, eye cuttings, tubers, bulbs, corms, rhizomes, stolons, grafts, cell culture and somatic embryonic material.

13. The method of claim 9, wherein the carbonaceous material is selected from the group consisting of biochar, activated carbon, coke, charcoal, anthracite, lignite, sub-bituminous, bituminous, flame coal, gas flame coal, gas coal, fat coal, forge coal, nonbanking coal, humin, lignin-containing biomass, a mixture of carbon nanostructure materials and mixtures thereof.

14. The method of claim 9, wherein the carbonaceous material is applied in an amount of less than 3% of the mass of the plant material, and preferably less than 1%.

15. The method of claim 9, wherein the carbonaceous material comprises a surface area of at least about 1 m²/gram, preferably greater than 100 m²/gr, and more preferably greater than 300 m²/gr.

16. The method of claim 9, wherein the carbonaceous material is applied at a thickness of no more than about 3 millimeters, and preferably a thickness of less than 3 millimeters, for example, less than 2 millimeters, or less than 1 millimeter.

17. A composition comprising an inert carbonaceous material combined with a binder.

18. The composition of claim 17, wherein the carbonaceous material comprises a surface area of at least about 1 m²/gram, preferably greater than 100 m²/gr, and more preferably greater than 300 m²/gr.

19. The composition of claim 17, wherein the carbonaceous material is selected from the group consisting of biochar, activated carbon, coke, charcoal, anthracite, lignite, sub-bituminous, bituminous, flame coal, gas flame coal, gas coal, fat coal, forge coal, nonbanking coal, humin, lignin-containing biomass, a mixture of carbon nanostructure materials and mixtures thereof.

20. The composition of claim 17, wherein the binder is selected from the group consisting of an aqueous solution, water, triglyceride based plant oils, glue, thickening agents and polymeric materials.

21. A method of inducing a microbial interaction with plant propagation material that confers a benefit on the plant propagation material comprising combining plant propagation material as defined in claim 1 with a growth medium comprising endogenous soil microorganisms.

22. (canceled)

23. (canceled)

24. (canceled)
